(19) United States
(12) Patent Application Publication
(10) Pub. No.: US 2020/0162519 A1
(43) Pub. Date: May 21, 2020

(54) VIDEO CONSULTING SYSTEM

(71) Applicant: Skin Authority L.L.C., Carlsbad, CA (US)

(72) Inventors: Celeste Hilling, Carlsbad, CA (US); Maurice Voce, Carlsbad, CA (US); Ted Hilling, Carlsbad, CA (US)

(21) Appl. No.: 16/192,702

(22) Filed: Nov. 15, 2018

(51) Int. Cl. H04L 29/06

(52) U.S. Cl. CPC H04L 65/1046; H04L 65/1096; H04L 65/1069; H04L 65/1006

(57) ABSTRACT

A system may provide for connecting customers with advisers in a flexible manner via connections providing video and audio interfaces while synchronizing customer specific data. The system may be used by a customer having a personal communication device running an application operable to provide for the customer, while in a physical store with one or more products, to select advice on at least one of the products in the store. The system may be operable for queuing a bank of advisers for connection via a video and audio interface on the customer's personal communication device of one of the advisers to the customer in response to the customer's selecting advice on the at least one product. The system may include a management server configured to connect to the customer's personal communication device to receive the customer's selection of advice and a call server connecting to the management server and providing access to the bank of advisers. The management server may assign one of the bank of advisers to the customer.

### FIELD

This disclosure relates to systems and methods for connecting customers with advisers in a flexible manner via connections providing video and audio interfaces while synchronizing customer specific data. More specifically, the disclosed embodiments relate to a system where multiple advisers are available, and each customer can connect with one of the advisers via a connection providing video and audio.

### INTRODUCTION

Traditionally, sales of skincare and cosmetic products occurred in a retail setting, with a customer in a store speaking directly with a salesperson who could evaluate the customer's needs and advise on appropriate products. In the store setting, the customer is able to try samples of products and the salesperson and customer can evaluate the results, but the cost of having sufficient salespersons with proper training available to handle varying customer demand is significant. The issues of whether or to what extent the cost of such salespersons should be borne by the owner/operator of the store or by the product-maker(s) whose products are in the store may be difficult to resolve.

As an alternative or addition to the in-store salespersons, a product-maker or another business involved in the selling of products to customers may provide for the customers to be able to call for assistance and advice relating to the capabilities, qualities, and applications of the products. Each customer may also be interested in an evaluation of the particular situations and requirements of the customer and how the products may best be selected, used, or applied for the customer's circumstances.

Typically, the business provides a telephone number or an online application for customers to be connected to a customer-service agent for assistance and advice. The business may train several customer-service agents in how to provide the assistance and advice. Such agents can be trained for a single maker's products or for products from multiple sources. A call-queue system may provide for connection of one agent from a bank of trained agents to connect to each incoming caller and then the agent can listen to the customer's questions and comments and provide appropriate assistance and advice based on the information exchanged with the customer.

Existing call-queue systems, e.g., LiveChat, connect each customer to one adviser automatically selected from a queue of available advisers, but only offer text and/or audio connections. These systems do not offer video-connected advisers and some markets, such as skincare and cosmetics, would benefit from the adviser being able to see the customer. The benefits from the video connection include both the adviser's being able to evaluate visually the customer's conditions and nonverbal communication, and the customer's having increased confidence in the adviser's evaluation.

Applications such as Facetime and Skype provide for video chat connections but generally the customer must set up the video chat on a one-to-one basis. That is, the customer must identify a particular Facetime or Skype user who is an adviser and connect to that particular user. For example, patients of some healthcare organizations may use such a video chat system to connect to a particular professional in the healthcare organization, but this requires scheduling an appointment in advance for a particular time. The lack of a queuing system for multiple advisers puts a burden on the customer to coordinate and/or schedule a video chat, which in turn deters the business from optimizing around a bank of trained customer-advice agents. This often results in the customer not receiving good advice, either because they fail to connect at all or the difficulty in connecting detracts from the experience, making re-use less likely.

A preferable scenario, from a customer's point of view, would be one where the customer can engage in a one-to-one video consultation with a trained agent to receive personalized, professional guidance on the selection and use of products simply by requesting help in a particular product area. Concurrently, from a seller's point of view, there is value in improving the customer's experience in seeking advice, particularly where the costs of providing the advice can be isolated and identified separately from other sales costs, such as the costs of operating the retail stores.

The costs of providing the advice include both the costs of training the agents and of providing the system for connecting the agents and customers. These costs may be decreased on a per-unit basis as the scale of customer engagement over a range of stores and products is increased. At the same time, a large-scale operation may still provide, via video chat, a sense of personalization and human touch in the advice provided to each customer. Where the technology automatically connects each customer via video chat to a trained agent, an improved system would provide for a customer experience of professional guidance equivalent in quality to the in-person, in-store experience but at a lower, and more readily defined, level of cost.

### SUMMARY

Embodiments of the present disclosure provide a system and a method for queuing advisers for connection via a video and audio interface of one of the advisers to each customer who seeks advice using the system and synchronizing customer specific data. The system may include an application operating on each customer's personal communication device that provides for a customer in a physical store or space to click on a link to get advice on particular products in the store. The term “personal communication device” will be understood to encompass any system or device by which a customer can carry out at least a portion of the communications described herein, including a smartphone running an app, a tablet or any other type of computer with appropriate network connectivity, a smart speaker with video capability, or such other devices as are capable of such communication in the future. The application may make use of the device's location information to identify the store and/or the products to the customer for selection.

In one or more embodiments, the system may provide for collection and analysis of information relating to the guidance provided via the video and audio interface. The system may include a database of information that covers the products involved and the agents and their training, and the results of the customers' usage of the system. The results stored and analyzed may include information about how the video guidance relates to sales information, such as the close rate, the ticket prices, and the re-purchase rates over a range of customer interactions.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a block diagram of a system providing for access by multiple customers using the personal communication devices of the customers through a network to a call server connecting to a bank of advisers under control of a management server that assigns an individual adviser to each customer.

FIG. 2 is a flowchart illustrating a method by which the call server connects a customer to an adviser selected from the bank of advisers.

FIG. 3 is a block diagram showing a set of connections for customers' personal communication devices via a telephone connection or an online application to a management server providing for browser-based user-interface.

FIG. 4 is a block diagram illustrating a connection via a video and audio interface of a customer with an adviser selected from a bank of advisers.

FIG. 5 is a block diagram illustrating an integration of a video connection system as described in FIGS. 1-4 with Customer Relationship Management (CRM) software.

FIG. 6 is a pictorial illustration of a user engaged in a video chat with an adviser.

FIG. 7 is a block diagram showing flow of information between a video chat session and integrated CRM software.

FIG. 8 is a continuation of a branch of the diagram in FIG. 7.

FIG. 9 is a screenprint of a smartphone running an app providing an option for a video chat session, as well as options for a voice call (audio-only session), a live chat (text session), and to request a call back.

### DESCRIPTION

Various aspects and examples of a system for video conferencing are described below and illustrated in the associated drawings. Unless otherwise specified, a combined system and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

As shown in FIGS. 1-4, a system 100 in accordance with one or more embodiments of the present invention, may be used to provide access by multiple customers 102, each using a personal communication device, such as tablets 104, through a network 106 to a call server 108 connecting to a bank of advisers 110 under control of a management server 112 that assigns individual advisers to each customer. Such a system may provide for connecting customers 102 with advisers 110 in a flexible manner via connections providing video and audio interfaces. For example, a customer 102 may connect through a personal communication device via an Internet connection 114. Alternately, a customer may connect through a local area network (LAN) or wide area network (WAN), which may be provided by a particular store or stores. The customer's personal communication device is preferably mobile, to facilitate use in a store, and may be handheld or supported by a suitable sleeve, case, and/or cover Alternatively any type of suitable communication device may be used, e.g., a laptop or a desktop computer, may be provided in a store for customer use or in some circumstances may be used in the customer's home.

Management server 112 may be connected to network 106 or a LAN or WAN by a suitable connection 116. Call server 108 may be connected to network 106 or a LAN or WAN by a suitable connection 118. Call server 108 and management server 112 are depicted in FIG. 1 as separate computers and may be alternatively be housed in the same computer.

Management server 112 may initially receive the requests from customers' personal communication devices to manage each customer's connecting to a particular adviser. For example, management server may provide a Web front end, which include provision of an initial page to the customer's personal communication device when the customer using a browser or another app selects a video coaching session. Typically the selection of the video coaching session would be from a browser page or another app screen associated with a particular set of products.

Management server 112 may also provide for management of a queue of callers who are requesting a video coaching session. Management of the queue may include keeping track of which advisers in the bank of advisers are currently available and assigning the call to a particular available adviser. Management server 112 may run any suitable operating system to support its capabilities and/or may make use of a virtualized or containerized system such as Docker (see www.docker.com). Preferably, management server 112 is configured for transportability, security, and stability so that it may coordinate reliably and securely between a wide variety of customers' personal communication devices and call servers. Management server 112 may provide for connection between customers' tablets and the advisers' server, e.g., by providing Session Initiation Protocol (SIP).

Call server 108 coordinates with management server 112 to effect and maintain connection between customers and advisers. For example, call server 108 may provide a Session Initiation Protocol (SIP) that includes a session border controller (SBC) that provides a back-to-back user agent (B2BUA). Call server 108 may mediate SIP signaling during the call so that each customer's video chat session can begin and continue as long as the customer and adviser want. Call server 108 may provide network address translator (NAT) traversal for the SIP signaling.

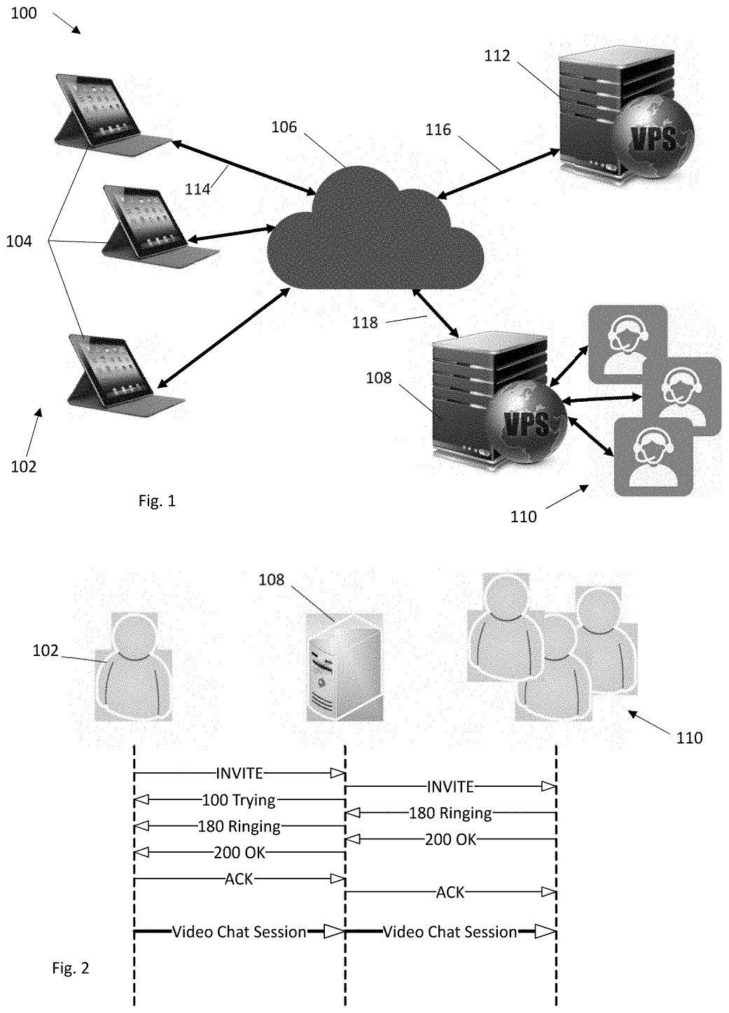

FIG. 2 shows an example of an initiation of a video chat session between a customer 102 and an adviser selected from a bank of advisers 110. The operation in FIG. 2 may, for example, occur after management server 112 has assigned a particular adviser to connect to customer 102. Under such circumstances, call server 108 may act as a B2BUA to receive and respond with signals as appropriate to initiate a video chat session with the customer's personal communication device. A typical call server 108 may be able to handle between about 5 to 10 active call sessions, although call server 108 may be implemented to handle less or more active call session as best suited for the particular application.

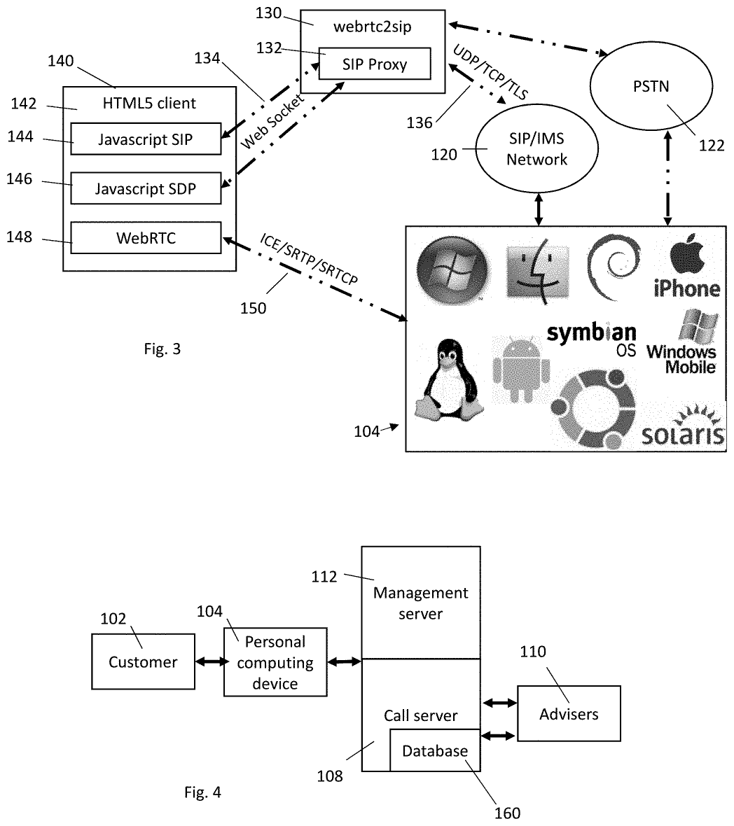

As shown in FIG. 3, software implemented preferably in call server 108, but alternatively in whole or in part in management server 112, may flexibly provide for connections between advisers and customers. The personal communication devices 104 of the customers are represented in FIG. 3 by typical operating systems for such devices, such as Linux, Android, Windows Mobile, and iPhone (aka iOS). Devices 104 can request, typically via a web page or an app, a video chat session over an SIP/Internet Protocol Multimedia Subsystem (IMS) 120 and/or over a public switched telephone network (PSTN) 122.

The server software may include a gateway 130 that allows a browser 140 accessible to the advisers (e.g., installed on call server 108) to act as a phone with audio, video, and SMS capabilities. Gateway 130 may be a Web Real Time Communication to SIP (webrtc2sip) interface and may include a module providing an SIP Proxy 132. The function of the SIP Proxy module is to provide conversion from a browser-based protocol, such as WebSocket protocol 134 to a SIP/IMS network protocol, such as User Datagram Protocol (UDP), Transmission Control Protocol (TCP), and/or Transport Layer Security (TLS). UDP, TCP and TLS 136 are protocols by which the SIP/IMS network can communicate with the customers' personal communication devices 104.

An HTMLS client 142 accessible within the adviser's browser 140 may include modules providing functionality for SIP 144 and Session Description Protocol (SDP) 146. The SIP and SDP modules may be written in any suitable language, e.g., Javascript. The HTMLS client may also include a Web Real Time Communication (WebRTC) module 148 supporting the communication functionality of the adviser's browser's. The WebRTC module 148 may provide for the adviser's browser's communicating with the customer's phone 104, e.g., by a connection 150 using a suitable protocol, such as one or more of the Interactive Connectivity Establishment (ICE) protocol, Secure Real-time Transport Protocol (SRTP), and/or Secure Real-time Transport Control Protocol (SRTCP).

Embodiments of the present disclosure provide a platform for communication between a product or service provider and customers for such products or services with several features. The platform allows for continuous engagement because of the ease with which each consumer can connect with an adviser qualified to counsel the consumer on the particular products or services. Such ease of connection is due at least in part to the platform's providing through management server 112 and/or call server 108 for each customer to request, based on product/service interest, and receive on demand prompt connection to an adviser for such product/service. The customer can then engage with the adviser to receive professional guidance via live visual 2-way dialogue. The adviser, who may be a certified professional, can see and hear each customer and can provide recommendations based on the visual and verbal observations. Additionally, each adviser can develop, enhance, and/or update a program for each customer that is personalized to each customer. Such program may allow the customer to improve in matters that relate to the products or services. For example, in the case of skin care products and services, the program may take into account the customer's skin type and concerns and recommend particular products and manners of using the products to alleviate such concerns.

As the customer uses the platform repeatedly, whether or not connecting with the same adviser each time, each adviser may have access to the personalized program for that customer. Each adviser can then enhance and update the program, and in this ongoing manner, provide the customer with a personalized improvement plan which can grow, adapt, and sustain over the customer's lifetime.

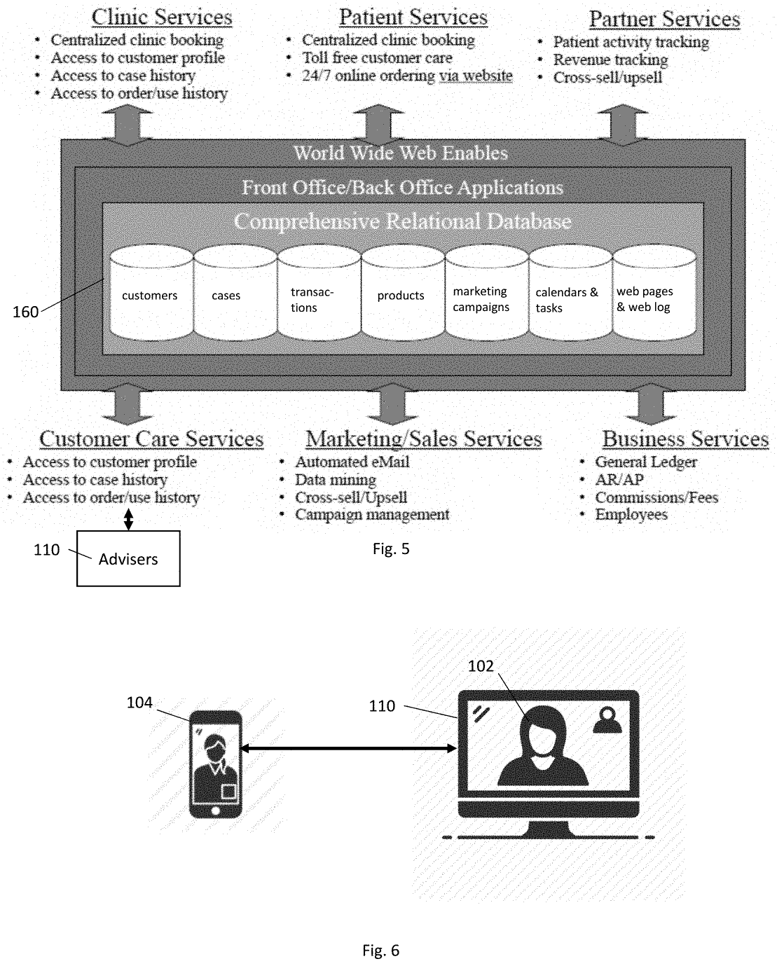

FIGS. 4 and 5 further illustrate how such a platform may operate. As shown in FIG. 4, customer 102 uses personal communication device 104 to request a video chat session with an adviser regarding a particular product, service, or a set of products or services. The customer may be using an app that the customer previously downloaded and installed on personal communication device 104, which app may be set up primarily for customers interested in the particular product, service, or set of products or services. Alternatively, the customer may be using a more general purpose app, such as a browser, and accessing a website of a product/service provider which includes functionality for requesting the adviser. The customer may be in physical location, such as a store, where one or more products/services are available, and the request for the adviser may be triggered by signage or labeling associated with the product/service, e.g., a barcode or an RF tag. In any case, the customer's request is relayed to a server, such as management server 112, which may be in communication with call server 108, which in turn may provide for connection to one or more advisers 110. Management server 112 and call server 108 then provide for connection via a video and audio interface of a particular adviser to customer 102. Advisers 110 may also have access to a database 160 located on a server, such as call server 108. The adviser may develop in database 160 the program personalized to the current customer and/or may access and read, and enhance and update an already existing program personalized to the current customer.

As shown in FIG. 5, database 160 may be associated with, and/or configured and maintained using any suitable software, for example, Customer Relationship Management (CRM) software. For example, NetSuite provides a CRM application, described at http://www.netsuite.com/portal/products/crm.shtml. Integration of the adviser system with the CRM application facilitates the maintaining of records of customer engagement and sales data with records of video chats with customers.

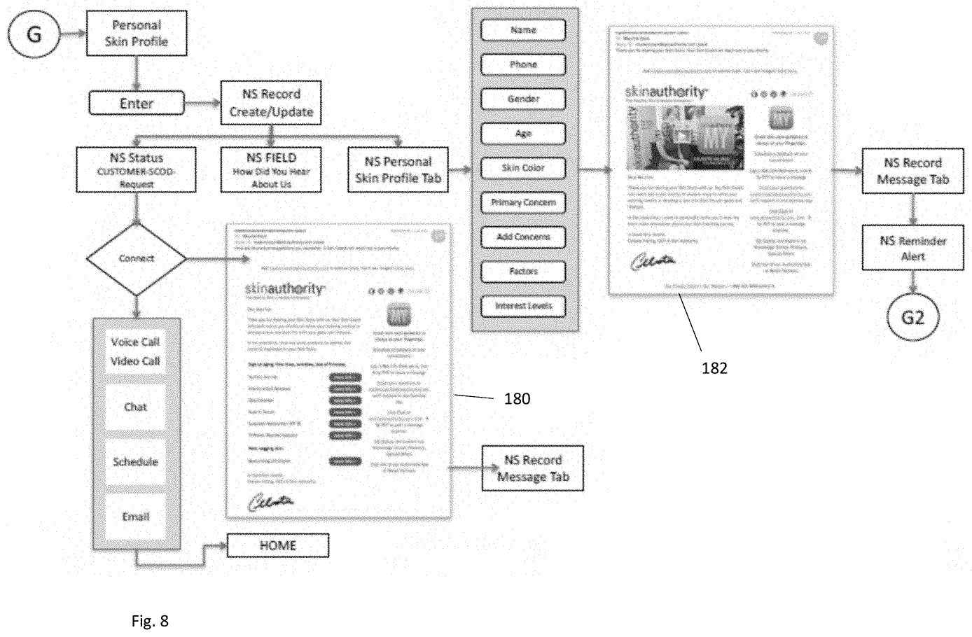

Each customer may have a customer profile, which may include information about the customer's product/service interest and personalized concerns identified by the customer. For example, a customer may be prompted on first use of an app implementing a portion of system 100 on the customer's phone to enter information, as may be seen in FIG. 8. This may include general contact, identification, and sourcing information relating to the customer as well as information specific to the particular application of the system. For example, in the case of the system providing for video chat sessions about skin care, the customer may be prompted to identify his or her gender, skin color, skin type, skin care concerns (such as signs of aging, discoloration, acne or breakouts, blotches, brown spots, dark circles around eyes, sensitized or dry skin, pore issues), factors affecting skin such as hormonal effects, health and weight, time concerns, interest level in skin care, and an option for identifying additional concerns. The customer profile may also include the personalized program developed by the advisers based on interactions, including video chat sessions, with the customer. Each adviser may have access to the customer profile and may additionally have access to product recommendations that may be based on the information contained in the customer profile. As an example of product recommendations, a customer profile identifying discoloration or spots as a concern may additionally provide a list of products designed for addressing such concern and the list may be further refined by additional information in the customer profile, e.g., information placed in the profile by an adviser during a video chat session.

As shown in FIG. 6, a video chat session typically involves the customer's smartphone 104, which customer 102 is aiming at the customer's face or other area that the customer wants the adviser to see. The customer's image is then depicted on the computer screen of adviser 110 to aid the adviser in visually observing, interpreting, and recording non-verbal cues to assist diagnosis or problem solving.

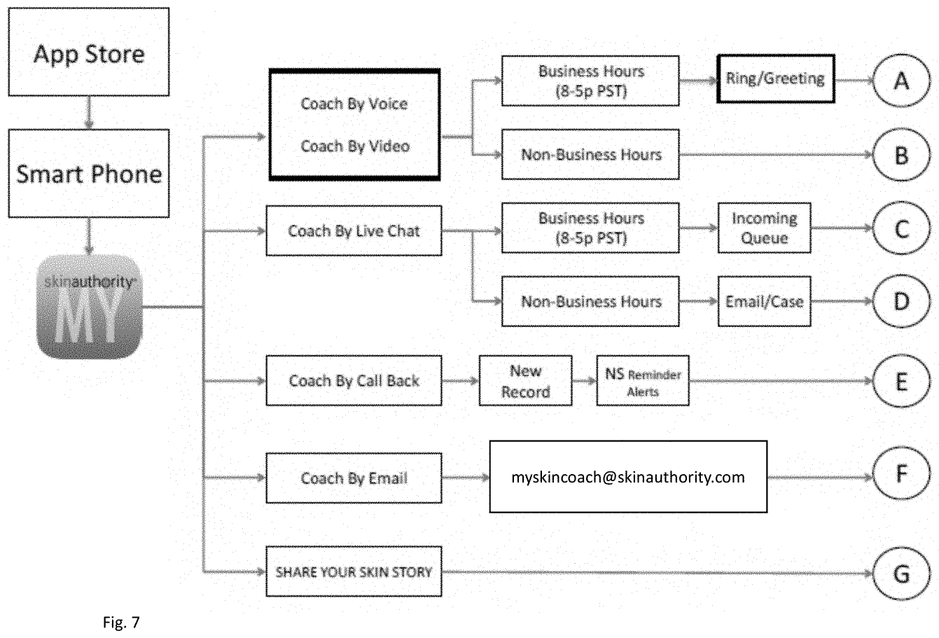

FIG. 7 is a flowchart depicting an example of how customer 102 may access and use an app on a communication device, such as a smartphone, which includes an option for a video chat session. For example, customer 102 may access an app store, such as the Google Play app store for an Android smartphone or the Apple App Store for an iPhone, and download an app that incorporates a vide chat session as one option. In the particular example of FIG. 7, the app is the My Skin Authority app offered by Skin Authority (www.skinauthority.com). While the My Skin Authority app is executing on the smartphone, the customer can access, in addition to “Coach by Video,” options for “Coach by Voice” (i.e., audio only), “Coach by Live Chat” (i.e., text messaging), “Coach by Call Back” (i.e., scheduling a later chat session), or “Coach by Email.” In addition, the app typically includes an option, such as “Share your skin story” for the customer to enter information about the customer's circumstances (e.g., skin type and issues) and product interests and questions.

As depicted in FIG. 7 in the chain of events leading to A, a customer selecting the “Coach by Video” option will, if calling during business hours, be connected to an adviser, for a video chat session as described for FIGS. 1-4 and 6, above. In the chain of events leading to B, a customer selecting the “Coach by Video” option outside of business hours may be routed to an automated or manual call scheduling service. FIG. 7 depicts a particular range for business hours, and alternatively, business hours may be around the clock and year-round to accommodate a global operation. If the customer selects options for “Coach by Voice,” the process is similar as to the video chat session but with audio only. A customer selecting “Coach by Live Chat” will be able to engage in a text messaging session at C or to schedule a later text messaging session at D. A customer selecting “Coach by Call Back” may schedule a later chat session at E. A customer selecting “Coach by Email” will be able to engage in an email exchange with an adviser at F.

A user selecting the option for “Share your skin story” leads at G for entering information for a customer profile as is further depicted in FIG. 8 and as described above. System 100 may, on the user's completing entry of a profile, send one or more emails to the user, e.g., an email 180 providing product recommendations based on the user's profile and/or an email 182 providing additional information about video chat sessions and other available advising options. As also shown in FIG. 8, the information in the customer profile may be stored in records accessible by the adviser, which may be used by the adviser in a video chat session, or in other types of sessions, to aid in the providing of advice.

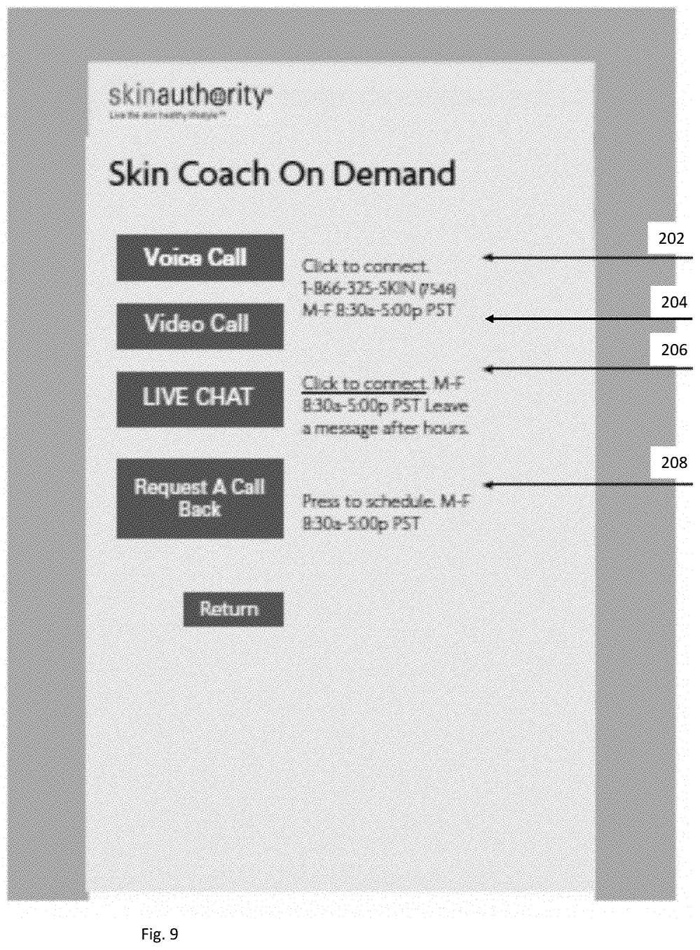

An app screen that includes the option for a video chat session is depicted in FIG. 9. The option for a voice call is at 202; the option for a video call is at 204; the option for live chat is at 206; the option to request a call back is at 208.

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

We claim:

1. A system for use by a customer having a personal communication device, wherein the customer's personal communication device is running an application, the application operable on the customer's personal communication device to provide for the customer, while in a physical store with one or more products, to select advice on at least one of the products in the store, the system operable for queuing a bank of advisers for connection via a video and audio interface on the customer's personal communication device of one of the advisers to the customer in response to the customer's selecting advice on the at least one product, the system comprising:
a. a management server configured to connect to the customer's personal communication device to receive the customer's selection of advice;
b. a call server connecting to the management server and providing access to the bank of advisers,
wherein the management server controls the assignment of the one of the bank of advisers to the customer.

2. The system of claim 1 wherein the system stores a set of customer specific data for the customer.

3. The system of claim 2 wherein the system stores the set of customer specific data for the customer in the call server.

4. The system of claim 2 wherein the system synchronizes availability to the adviser of the set of customer specific data with the adviser's connecting on the video and audio interface with the customer.

5. A system for selecting an adviser for connection via a video and audio interface to a customer who seeks advice using a personal communication device configured to connect to the system, the system comprising:
a. a management server configured to connect to the customer's personal communication device to receive the customer's selection of advice;
b. a call server connecting to the management server and providing access to the adviser,
wherein the management server controls the assignment of the adviser to the customer.

6. The system of claim 5 wherein the system stores a set of customer specific data for the customer.

7. The system of claim 6 wherein the system stores the set of customer specific data for the customer in the call server.

8. The system of claim 6 wherein the system synchronizes availability to the adviser of the set of customer specific data with the adviser's connecting on the video and audio interface with the customer.

9. The system of claim 5 wherein the personal communication device is a smartphone.

10. The system of claim 5 wherein the personal communication device is a smartphone. a tablet.

11. The system of claim 5 wherein the personal communication device is a computer with network connectivity.

12. The system of claim 5 wherein the personal communication device is a smart speaker with video capability

13. The system of claim 5 wherein the personal communication device includes a capability for determining and outputting a current location of the device, and where the application uses the device's location information to identify to the management server at least one of a store and a product proximate to the customer.

14. The system of claim 5 wherein at least one of the management server and the call server are configured to provide for collection of information relating to communications between the adviser and the customer via the video and audio interface.

15. The system of claim 14 wherein the collected information includes data relating to at least one of a close rate, a ticket price, or a re-purchase rate.

16. The system of claim 5 further including a database of information relating to a set of products stored in at least one of the management server and the call server.

17. The system of claim 5 wherein the management server provides an initial page to the customer's personal communication device when the customer seeks to connect for advice to the video and audio interface.

18. The system of claim 5 wherein the management server is configured to keep track of a current availability of a bank of advisers in order to select the adviser to connect to the customer.

19. The system of claim 5 wherein the call server coordinates with the management server by providing a Session Initiation Protocol (SIP).

20. A system for use by a customer having a personal communication device, wherein the customer's personal communication device is running an application, the application operable on the customer's personal communication device to provide for the customer, while in a physical store with one or more products, to select advice on at least one of the products in the store, the system operable for queuing a bank of advisers for connection via a video and audio interface on the customer's personal communication device of one of the advisers to the customer in response to the customer's selecting advice on the at least one product, the system comprising:
a. a management server configured to connect to the customer's personal communication device to receive the customer's selection of advice;
b. a call server connecting to the management server and providing access to the bank of advisers,
wherein the management server controls the assignment of the one of the bank of advisers to the customer, and
wherein the call server stores a set of customer specific data for the customer, and wherein the call server synchronizes availability to the adviser of the set of customer specific data with the adviser's connecting on the video and audio interface with the customer.
